(19) United States
(12) Patent Application Publication
(10) Pub. No.: US 2011/0233089 A1
(43) Pub. Date: Sep. 29, 2011

(54) Caddy For Use With A Tool Case Such As A Drill Index Box

(76) Inventor: Frank Charles Verk, Batesburg, SC (US)

(21) Appl. No.: 12/729,359

(22) Filed: Mar. 23, 2010

(51) Int. Cl. B25H 3/04; B65D 85/20; B65D 51/00; B65D 25/22

(52) U.S. Cl. 206/379; 206/1.5; 220/751

(57) ABSTRACT

A caddy for use with a drill index box includes a base member configured to receive the drill index box. An attachment device is rotatably coupled to the base member, the attachment device having means for coupling to a wall when the attachment device is rotated to a first position relative to the base member. The attachment member may be coupled to a pegboard when the attachment device is rotated to a second position relative to the base member, the first position being distinct from the second position. The caddy includes a locking bar movably coupled to the base member to selectively restrain the drill index box between the base member and the locking bar.

### BACKGROUND OF THE INVENTION

This invention relates generally to tool containers and, more particularly, to a caddy for use with a tool box or other container such as a drill index box.

A drill index box contains drill bits of various sizes and often keeps them arranged in a convenient manner for use by a workman. Unfortunately, the drill index is quite easy to become knocked over and spilled when situated on a work bench, such as by power cords from electric tools or by the arms of the workman. If small drill bits fall to the floor as a result, they may be difficult to find or, at the very least, require undesirable stooping and wasteful time inefficiencies. Another problem associated with keeping a drill index box on the workbench is that it collects wood chips, dirt, paint or other aerosol overspray, and the like. Further, keeping an index box close at hand when working away from a workbench is difficult and may require stooping repeatedly to select a needed drill bit from an index box that is positioned on the floor or ground. This is especially problematic when a workman repeatedly makes use of one size for making a starter hole and another size for making a completed hole.

Various devices have been proposed in the industry for holding an index box in a more convenient manner. Although assumably effective for their intended purposes, the existing devices and proposals do not provide a caddy that is selectively attachable to a toolbox or pegboard and which can effectively close or even lock up a drill bit index box.

Therefore, it would desirable to have caddy for use with a tool case such as a drill index box that is able to secure the index box and be selectively and removably coupled to a tool box or pegboard. Further, it would be desirable to have a caddy in which a few spare drill bits of commonly used sizes may be held apart from an index box.

### SUMMARY OF THE INVENTION

A caddy for use with a drill index box according to the present invention includes a base member configured to receive the drill index box. An attachment device is rotatably coupled to the base member, the attachment device having means for coupling to a wall when the attachment device is rotated to a first position relative to the base member. The attachment member may be coupled to a pegboard when the attachment device is rotated to a second position relative to the base member, the first position being distinct from the second position. The caddy includes a locking bar movably coupled to the base member to selectively restrain the drill index box between the base member and the locking bar.

A general object of this invention is to provide a caddy for use with a tool case such as a drill index box having a locking bar for selectively restraining the index box between a base member and the locking bar.

Another object of this invention is to provide a caddy, as aforesaid, having an attachment device for selectively coupling the caddy to a tool box or a wall.

Yet another object of this invention is to provide a caddy, as aforesaid, that prevents spillage of drill bits from a drill index box.

A further object of this invention is to provide a caddy, as aforesaid, that is easy to use and economical to manufacture.

A still further object of this invention is to provide a caddy, as aforesaid, that reduce the amount of dirt, wood chips, and the like that accumulates in a drill index box.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a caddy according to a preferred embodiment of the present invention in use with a drill index box;

FIG. 2 is a rear perspective view of the caddy as in FIG. 1;

FIG. 3 is another perspective view of the caddy as in FIG. 1 with the locking bar shown in an open configuration;

FIG. 4 is another perspective view of the caddy as in FIG. 2 in use with an attachment member;

FIG. 5 is a perspective view of the caddy as in FIG. 3 with the index box removed; and

FIG. 6 is another perspective view as in FIG. 4 with the index box removed.

### DESCRIPTION OF THE PREFERRED EMBODIMENT

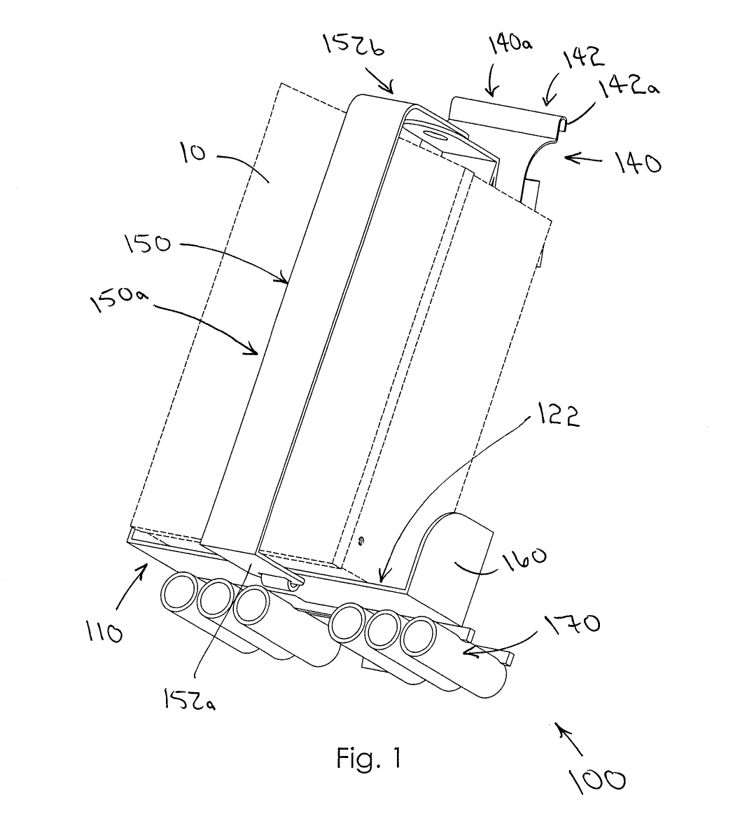

Caddies according to the present invention will now be described in detail with reference to FIGS. 1 through 6 of the accompanying drawings. More particularly, a caddy 100 for use with a tool case (e.g., a drill index box) 10 according to one embodiment includes a base member 110, an attachment device 140 rotatably coupled to the base member 110, and a locking bar 150.

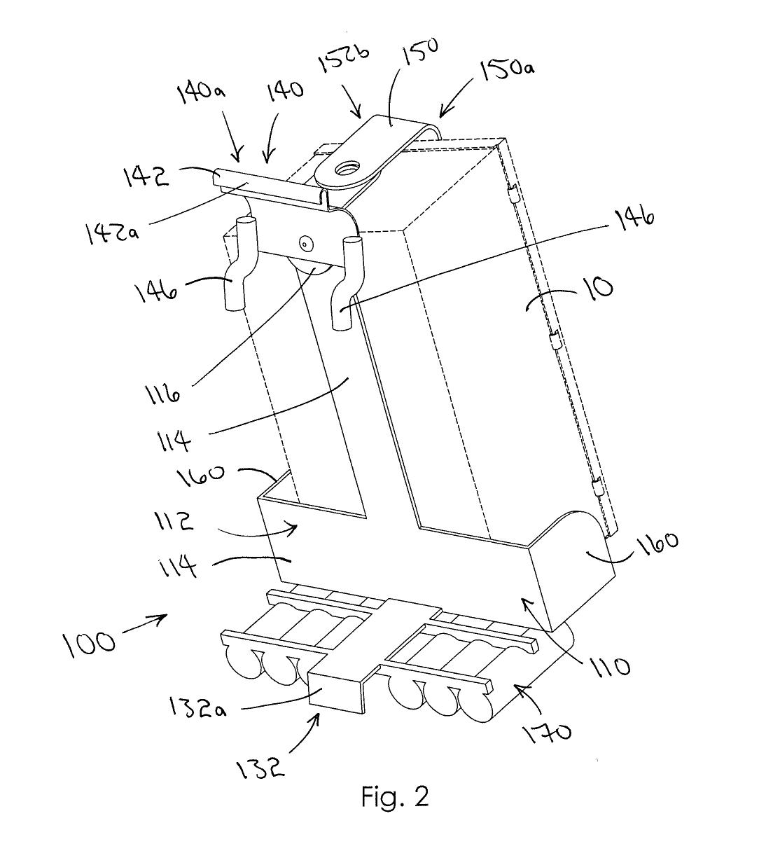

The base member 110 is configured to receive the drill index box 10 and includes a back portion 112 (FIGS. 2, 4, 5, and 6) and a shelf portion 122 (FIGS. 1, 3, 5, and 6). As shown throughout the figures, it may be desirable for the shelf portion 122 to be angled relative to the horizon when the attachment device 140 is coupled to a wall or a pegboard (as discussed further below; the wall/pegboard not being shown in the drawings) to retain the drill index box 10 upon the shelf portion 122.

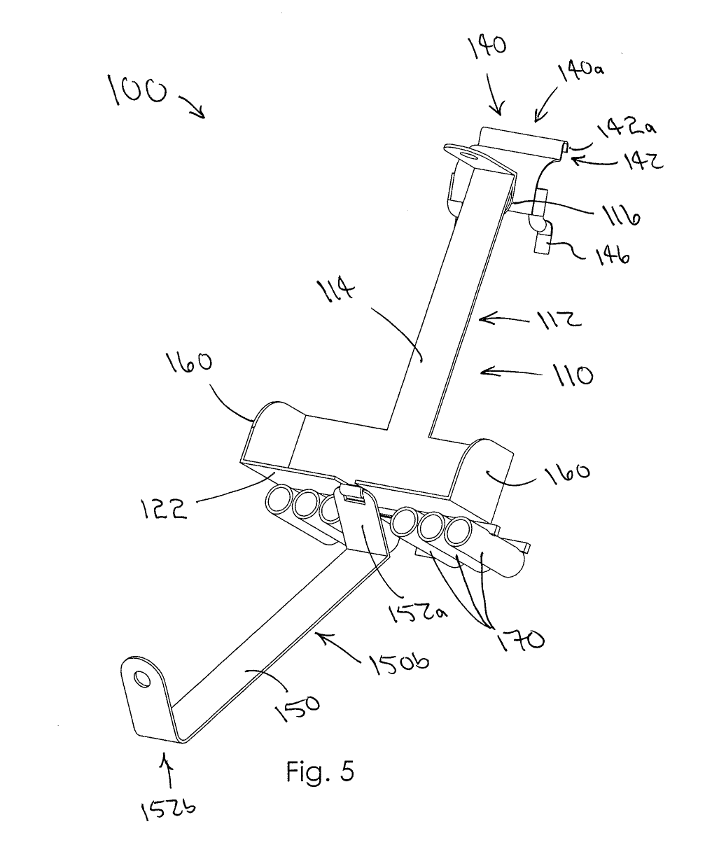

The back portion 112 may include a rear wall 114 (FIGS. 2, 4, 5, and 6) and a flange 116 (FIGS. 2 and 5), and the attachment device 140 may be rotatably coupled to the back portion 112. In some embodiments, the rear wall 114 extends from the shelf portion 122, and it may be desirable for the rear wall 114 to extend generally perpendicularly to the shelf portion 122. The flange 116 may be angularly offset from the rear wall 114, as shown in FIG. 5, and it may be desirable for the attachment device 140 to be rotatably coupled to the flange 116 (e.g., by a rivet, pin, etc.).

Turning to FIGS. 2, 4, and 6, a spacer 132 may extend from the base member 110 (e.g., from the rear wall 114, such that the rear wall 114 is between the spacer 132 and the shelf portion 122) to support the base member 110 (and the rear wall 114 in particular, for example) when the attachment device 140 is coupled to a wall or pegboard. Portion 132a may extend generally parallel to the wall or pegboard, as will be appreciated by those skilled in the art, and it may be desirable for portion 132a to be padded (e.g., by felt, etc.).

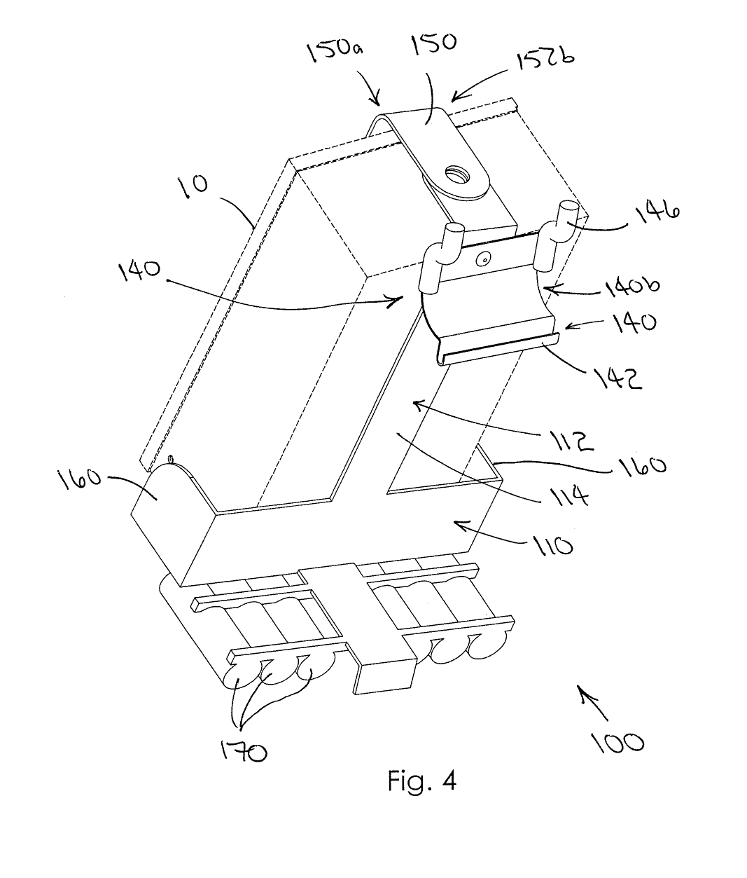

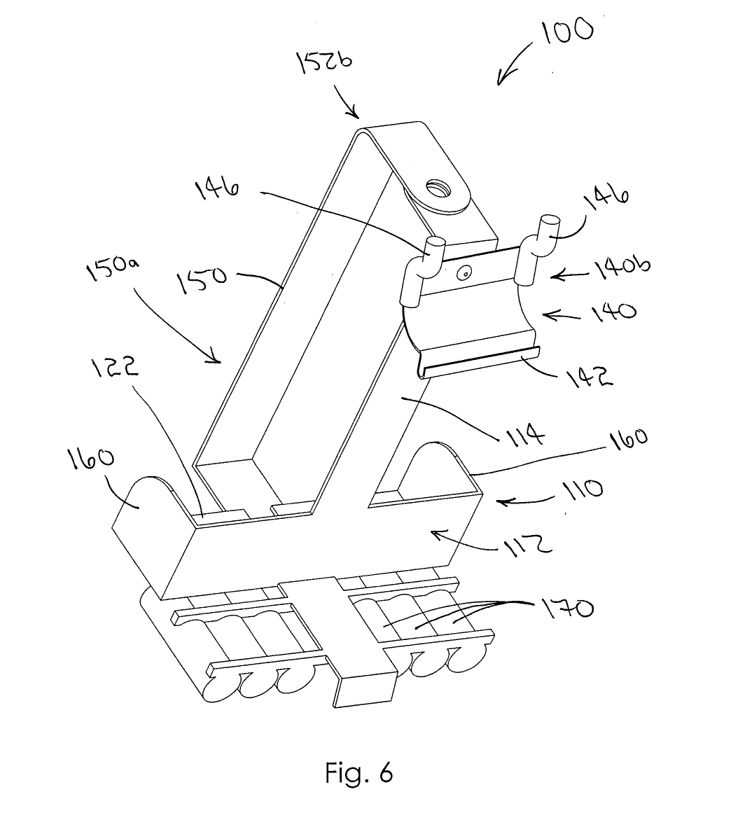

The attachment device 140 has means for coupling to a wall when the attachment device 140 is rotated to a first position 140a relative to the base member 110 (FIGS. 1, 2, 3, and 5), and means for coupling to a pegboard when the attachment device 140 is rotated to a second position 140b relative to the base member 110 (FIGS. 4 and 6). The first position 140a is distinct from the second position 140b, and the first position 140a may be offset about 180° from the second position, as shown in the drawings. The means for coupling to a wall may for example include a hook 142 configured to suspend the base member 110 from a wall, and it may be desirable for the hook 142 to be elongate with a lip 142a for securement to a wall. The means for coupling to a pegboard may for example include a pin 146 configured to pass through a hole in a pegboard and couple the base member 110 to the pegboard.

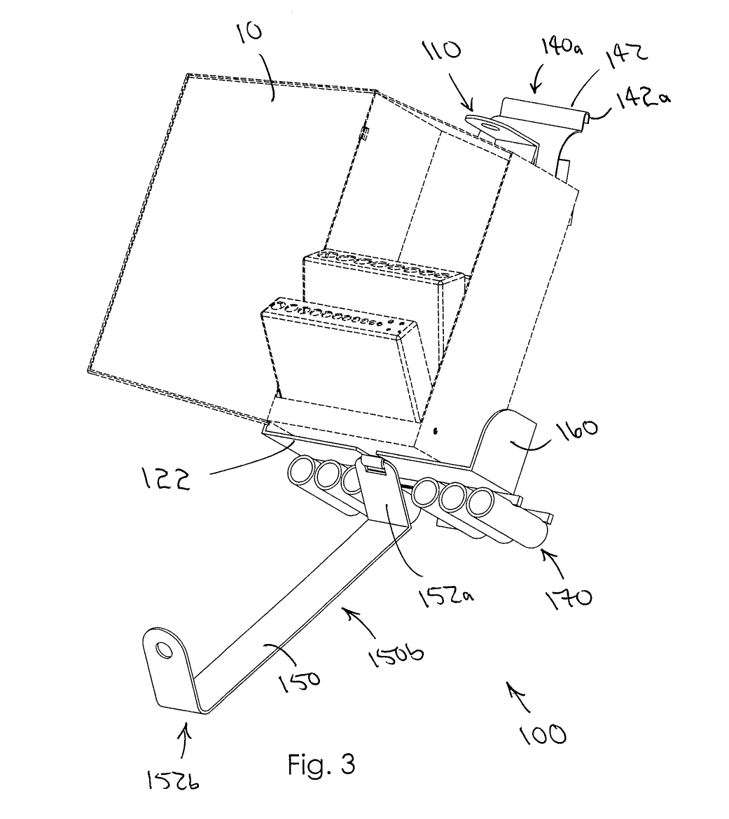

The locking bar 150, best shown in FIGS. 1, 3, 5, and 6, is movably coupled to the base member 110 to restrain the drill index box 10 between the base member 110 and the locking bar 150 when at a closed configuration 150a (FIGS. 1 and 6), and to allow the drill index box 10 to separate from the base member 110 when at an open configuration 150b (FIGS. 3 and 5). More particularly, the locking bar 150 may have a lower end 152a rotatably coupled to the shelf portion 122 and an upper end 152b selectively coupled to the base member (e.g., by a catch or lock, not shown in the drawings), such that the locking bar 150 extends completely across the drill index box 10 and the drill index box 10 is between the rear wall 114 and the locking bar when the locking bar 150 is at the closed configuration 150a.

Lateral flanges 160, shown throughout the drawings, extend from the base member 110 in a manner that makes the drill index box 10 inseparable from the base member 110 when the locking bar 150 is at the closed configuration 150a, restraining the drill index box between the rear wall 114 and the locking bar 150. In other words, the lateral flanges 160 may prohibit the drill index box 10 from be separated laterally from the base member 110.

Also shown throughout the drawings, a plurality of auxiliary bit storage sleeves 170 may be below the shelf portion 122. The auxiliary bit storage sleeves 170 may, for example, include hollow tubes operatively coupled to the base member 110 for receiving drill bits and/or other items.

Though specific materials are generally not discussed at length above, those skilled in the art will appreciate that the various elements set forth herein may be constructed of metal (e.g., steel, aluminum, etc.), plastic, and/or any other appropriate materials.

In use, the attachment device 140 may be rotated between the first and second positions 140a, 140b, depending on whether the hook 142 or the pin 146 is needed for coupling. When the attachment device 140 is coupled to a wall or pegboard, the tool case 10 may be maintained on the shelf portion 122, particularly due to the angle of the shelf portion 122 described in detail above. The locking bar 150 may be moved to the closed configuration 150a to restrain the tool case 10 from separating from the base member 110. Even with the locking bar 150 at the open configuration 150b, however, the angle of the shelf portion 122 may allow the tool case 10 to remain on the shelf portion 122. With the locking bar 150 at the closed configuration 150a, access to the contents of the tool case 10 may be restricted. The lateral flanges 160 may prevent the tool case 10 from being removed laterally from the base member 110, and the auxiliary bit storage sleeves 170 may be used to house additional items (e.g., drill bits). It should be understood that the tool case 10 may be coupled to the base member 110 either before or after the attachment device 140 is utilized, and that the tool case 10 may be transported while coupled to the base member 10.

It is understood that while certain forms of this invention have been illustrated and described, it is not limited thereto except insofar as such limitations are included in the following claims and allowable functional equivalents thereof.

1. A caddy for use with a drill index box, said caddy comprising:
a base member configured to receive the drill index box;
an attachment device rotatably coupled to said base member, said attachment device having means for coupling to a wall when said attachment device is rotated to a first position relative to said base member, said attachment device having means for coupling to a pegboard when said attachment device is rotated to a second position relative to said base member, said first position being distinct from said second position; and
a locking bar movably coupled to said base member to selectively restrain the drill index box between said base member and said locking bar.

2. The caddy of claim 1, wherein said base member has a back portion and a shelf portion, said shelf portion being angled relative to the horizon when said attachment device is coupled to a wall or a pegboard to retain the drill index box upon said shelf portion.

3. The caddy of claim 2, wherein said attachment device is rotatably coupled to said back portion.

4. The caddy of claim 3, wherein said back portion includes:
a rear wall extending from, and generally perpendicularly to, said shelf portion such that said locking bar selectively restrains the drill index box between said rear wall and said locking bar; and
a flange extending from said rear wall, said attachment device being rotatably coupled to said flange.

5. The caddy of claim 4, wherein said base member includes lateral flanges such that the drill index box is inseparable from said base member when said locking bar restrains the drill index box between said rear wall and said locking bar.

6. The caddy of claim 5, further comprising a spacer extending from said rear wall to support said rear wall when said attachment device is coupled to a wall or a pegboard, said rear wall being between said spacer and said shelf portion.

7. The caddy of claim 6, wherein said locking bar has a lower end rotatably coupled to said shelf portion and an upper end selectively coupled to said base member.

8. The caddy of claim 7, further comprising a plurality of auxiliary bit storage sleeves below said shelf portion.

9. The caddy of claim 8, wherein said means for coupling to a wall includes a hook configured for attachment to a wall, and wherein said means for coupling to a pegboard includes a pin configured to pass through a hole in a pegboard.

10. The caddy of claim 2, further comprising a spacer extending from said back portion to support said back portion when said attachment device is coupled to a wall or a pegboard, said back portion being between said spacer and said shelf portion, and wherein said base member includes lateral flanges such that the drill index box is inseparable from said base member when said locking bar restrains the drill index box between said base member and said locking bar.

11. A shop caddy for use with a tool case, said caddy comprising:
a base member configured to receive the tool case;
an attachment device rotatably coupled to said base member, said attachment device having a hook for suspending the base member from a wall when said attachment device is rotated to a first position relative to said base member, said attachment device having a pin configured to pass through a hole in a pegboard and couple the base member to the pegboard when said attachment device is rotated to a second position relative to said base member, said first position being different from said second position; and
a locking bar movably coupled to said base member to restrain the tool case between said base member and said locking bar when at a closed configuration and allow the tool case to separate from said base member when at an open configuration.

12. The caddy of claim 11, wherein said base member has a back portion and a shelf portion, said shelf portion being angled relative to the horizon when said attachment device is coupled to a wall or a pegboard to retain the tool case upon said shelf portion, and wherein said attachment device is rotatably coupled to said back portion.

13. The caddy of claim 12, wherein:
said back portion includes a rear wall extending from, and generally perpendicularly to, said shelf portion such that said locking bar selectively restrains the tool case between said rear wall and said locking bar; and
further comprising a spacer extending from said rear wall to support said rear wall when said attachment device is coupled to a wall or a pegboard, said rear wall being between said spacer and said shelf portion.

14. The caddy of claim 13, wherein said base member includes lateral flanges such that the tool case is inseparable from said base member when said locking bar restrains the tool case between said rear wall and said locking bar.

15. The caddy of claim 14, wherein said first position relative to said base member is offset about 180° from said second position relative to said base member.

16. The caddy of claim 15, further comprising a plurality of auxiliary bit storage sleeves below said shelf portion.

17. The caddy of claim 15, further comprising a plurality of auxiliary bit storage sleeves operatively coupled to said base member.
